(19) United States
(12) Patent Application Publication
(10) Pub. No.: US 2018/0229752 A1
(43) Pub. Date: Aug. 16, 2018

(54) HEATED STEERING WHEEL SYSTEM

(71) Applicant: Ford Global Technologies, LLC, Dearborn, MI (US)

(72) Inventors: James Robert CHASCSA, II, Farmington Hills, MI (US); Adam DUBAISI, Dearborn, MI (US); Michael Joseph DEAN, Westland, MI (US); Sean B. WEST, Monroe, MI (US)

(21) Appl. No.: 15/434,402

(22) Filed: Feb. 16, 2017

(51) Int. Cl. B62D 1/06; B60R 16/037; B60K 35/00; B60R 16/03; H05B 1/02

(52) U.S. Cl. CPC B62D 1/065; B60R 16/037; B60K 35/00; B60K 2350/106; H05B 1/0236; B60K 2350/1076; B60R 16/03

(57) ABSTRACT

A system may include a steering wheel assembly including a plurality of heat mat sections configured to selective heat a subset of the steering wheel, and a controller coupled to the heat mat sections via at least one connector, the controller configured to instruct the connector to provide current to at least one of the heat mat sections based on a user preference associated with an identified user.

### TECHNICAL FIELD

Disclosed herein are heated steering wheel systems.

### BACKGROUND

Vehicles often include steering wheels that are capable of being heated. These steering wheels may be heated via a resistive mesh surrounding the steering wheel. However, such systems are often not personalized to a specific user.

### SUMMARY

A steering wheel system may include a steering wheel assembly including a plurality of heat mat sections configured to selective heat a subset of the steering wheel, and a controller coupled to the heat mat sections via at least one connector, the controller configured to instruct the connector to provide current to at least one of the heat mat sections based on a user preference associated with an identified user.

A steering wheel assembly may include a steering wheel and a plurality of heat mat sections surrounding the steering wheel and configured to selective heat a respective subset of the steering wheel, and a controller coupled to the heat mat sections via at least one connector, the controller configured to instruct the connector to provide current to at least one of the heat mat sections based on a user preference associated with an identified user.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example heated steering wheel system;

FIG. 2 illustrates an exploded view of a steering wheel assembly;

FIG. 3 illustrates a front view of the steering wheel assembly of FIG. 2 with steering wheel sections shown in phantom;

FIG. 4 illustrates a schematic of the heated steering wheel system of FIG. 1; and

FIG. 5 illustrates an example user interface for the heated steering wheel system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is a steering wheel system capable of heating a vehicle steering wheel to a user's preference. In one example, certain portions of the steering wheel will be heated, while other portions will not. Certain portions may be heated prior to other portions. A user may select his or her preferences via a user interface either at the user's mobile device, or at the vehicle display. User preferences may be applied upon detection of the user by the vehicle. In one example, upon recognizing a key fob associated with a user, preferences associated with the user may be applied.

Each steering wheel section may include a sensor configured to provide a temperature of the heat mat to the controller. The sensor may transmit the temperature to a controller, which may compare the temperature with the stored user preferences. The controller may also control which heat mat sections are heated based on the stored user preferences. Because the steering wheel system heats certain sections of the steering wheel, power is only applied to those sections, limiting the amount of power required to heat the steering wheel. Further, small areas are heated, allowing for sections to heat faster, and maintain a temperature more easily than systems that heat an entire wheel.

The heat mats of each steering wheel section may be connected with a controller through a connector configured to allow current to pass to the heat mats upon receiving an identified user. The connector may also receive feedback from the heat mat section, such as a temperature, and adjust any current supply thereto based on the temperature. Accordingly, a more user friendly, efficient, and functional heated steering wheel system is described herein.

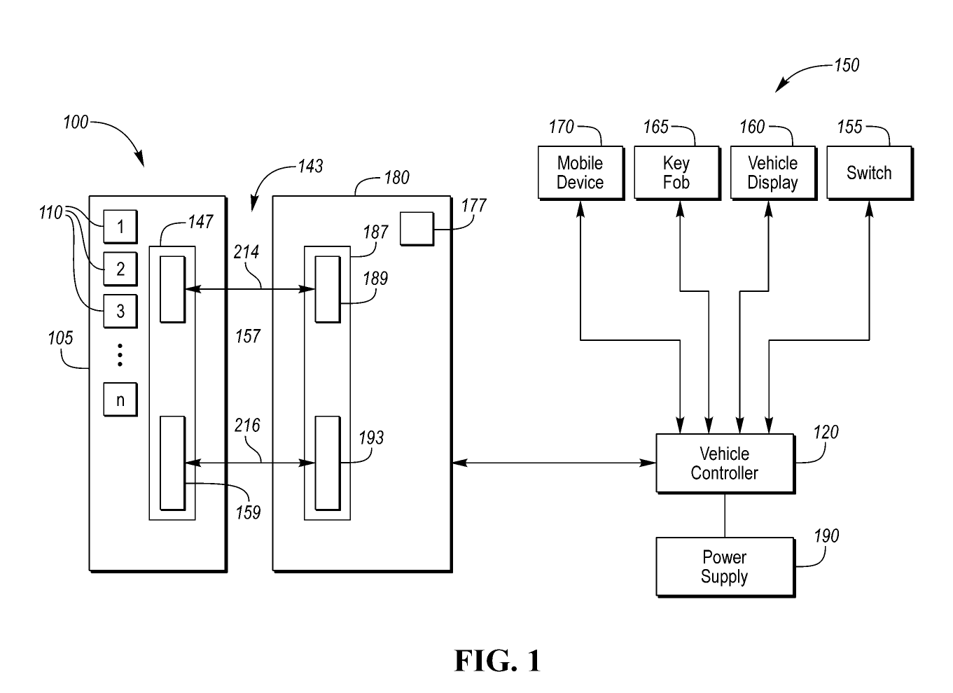

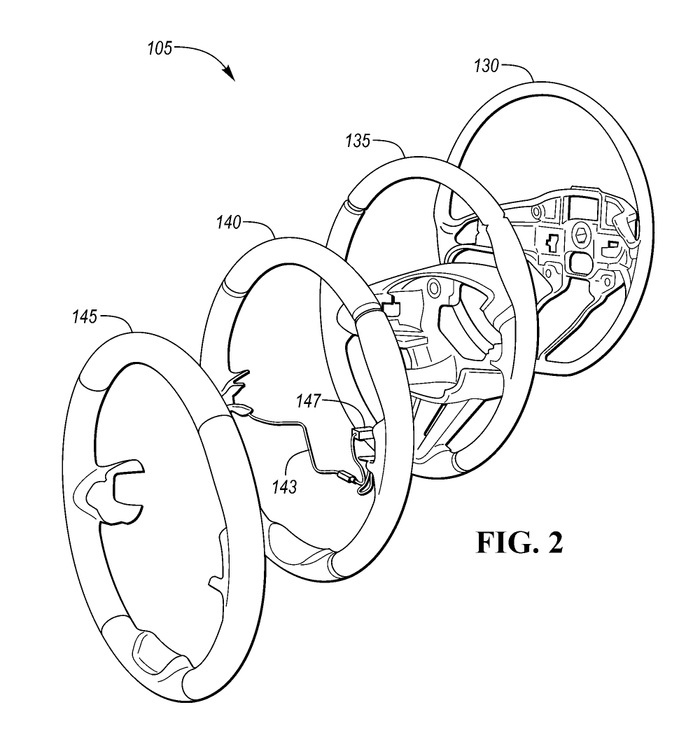

FIG. 1 illustrates an example heated steering wheel system 100 for a vehicle steering wheel. The system 100 may include a steering wheel assembly 105 having a plurality of heat mat sections 110 (as also shown in FIG. 2). Each heat mat section 110 may be individually controlled and heated based on a user's preference. The steering wheel system 100 also includes a vehicle controller 120 configured to control and monitor the heat mat sections 110 of the steering wheel assembly 105. The steering wheel assembly 105 may be a control interface configured to control a steering system of a vehicle.

Referring to an exploded view of the steering wheel assembly 105 in FIG. 2, the steering wheel assembly 105 may include various components including a frame 130. The frame 130 may be constructed of metal, or other hard material. A foam, such as a polyurethane foam, may surround the frame 130. The foam may provide a soft surface for the steering wheel assembly 105.

A heat mat 140 may surround the foam. The heat mat 140 may be a mat capable of conducting heat. In one example, the heat mat 140 may be a resistive mesh (e.g. a compilation of wires) having a positive heat coefficient. The mesh may be made of copper or beryllium material. By supplying a current to the heat mat 140, the heat mat 140 may become heated, or warm, due to the current supplied thereto. As the temperature of the mat 140 increases, as does the resistance.

An outer surface wrapping 145 may surround the heat mat 140. The surface wrapping 145 may be leather, or other suitable material for covering the heat mat 140 and providing a smooth and durable surface around the steering wheel assembly 105.

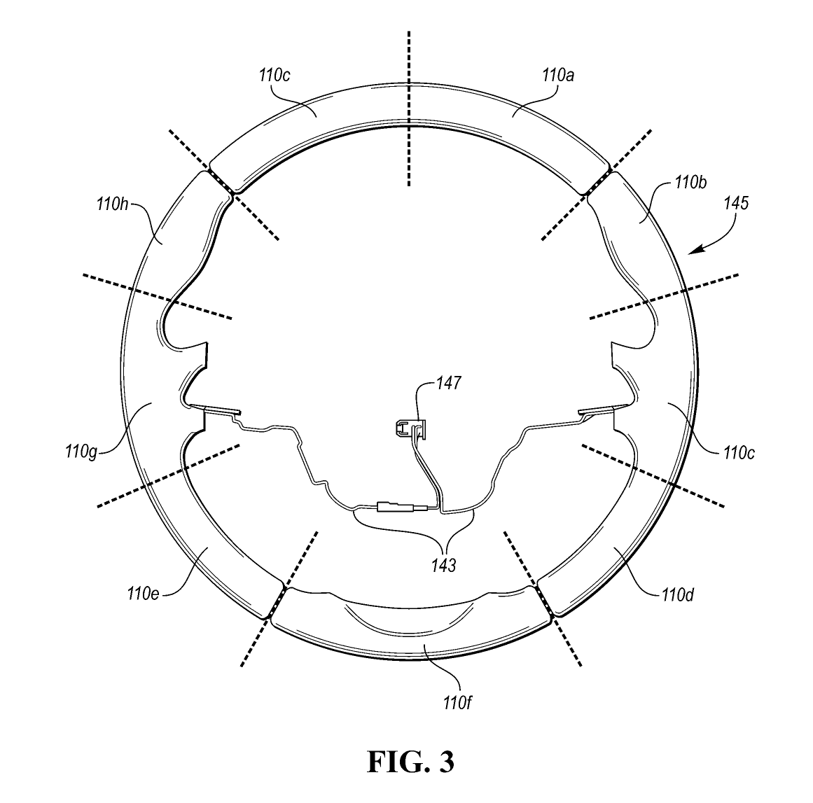

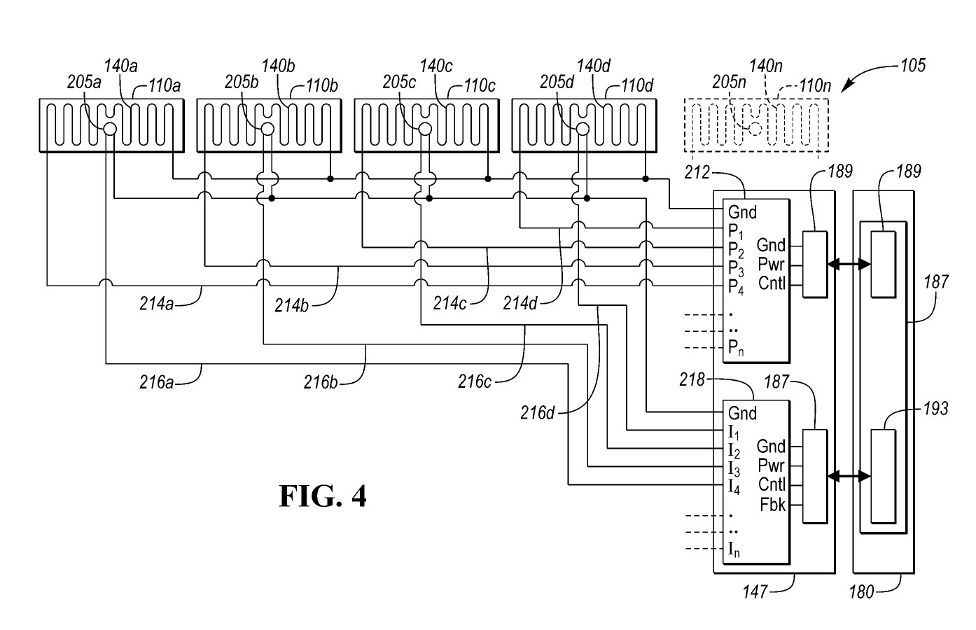

The heat mat 140 may be connected to at least one wire 143 (including both the first wire 214 and the second wire 216 of FIGS. 3 and 4 and described with respect to the same). In one example, a wire 143 (e.g., first wire 214) may extend from each heat mat section 110 to individually supply current to a specific heat mat section 110. In another example, the wire 143 (e.g., a second wire 216) may extend from a sensor of each heat mat section 110 to provide a feedback signal or data to the vehicle controller 120 and/or the steering wheel controller 180.

Each wire 143 may be attached to a steering wheel connector 147. The steering wheel connector 147 may be a pin housing connector capable of receive the wire 143 and transmitting current thereto from a power supply. This is discussed in more detail below with respect to FIGS. 3 and 4.

FIG. 3 illustrates a front view of the heat mat 140 of the example steering wheel assembly 105. The heat mat 140 may include a plurality of heat mat sections 110. Each heat mat section 110, also referred to herein as the heat mat sections 110a-i, may include an individual heat mat 140, referred to herein as the heat mats 145a-i. Although nine heat mat sections 110a-i are illustrated in FIG. 3, this amount of sections is for example purposes only and more or less heat mat sections 110 may form the collective heat mat 140.

Each heat mat 140a-i may be individually controlled wherein current may be selectively supplied thereto to heat the specific heat mat 140a-i.

A user may select his or her preferences on which of the heat mat sections 110a-i are to be heated. As explained, this may be done via a user interface on the vehicle display 160. A database may maintain the user preferences and recall the preferences upon detecting the user as the driver. This detection may be accomplished by the key fob identifier, the mobile device 170 or the switch 155. In one example, the user may prefer for heat mat sections 110h and 110b to be heated first and foremost. The user preferences may also include a desired temperature. Current to a specific heat mat section 110 may be supplied based on these preferences. Additionally, current may be cut off from certain heat mat sections 110 once a desired temperature is achieved.

Returning back to FIG. 1, the vehicle controller 120 may include a processor configured to carry out instructions for the systems and methods disclosed herein. In one example, the vehicle controller 120 may be a special purpose controller for the heated steering wheel system 100. In another example the vehicle controller 120 may be an on-board vehicle controller such as a body control module. Although not shown, the vehicle controller 120 may also be remote from the vehicle and configured to communicate with another on-board controller for carrying out instructions for the vehicle steering wheel assembly 105.

The vehicle controller 120 may interface and communicate with various vehicle interfaces 150. The vehicle interfaces 150 may include devices capable of receiving user input. The interfaces 150 may include items such as an in-vehicle switch 155, a vehicle display 160, a key fob 165, a user device 170, etc.

The switch 155 may be a button or interface configured to select a user. The switch 155 may include a plurality of switch positions such as 1, 2, 3, etc. Each switch position may correspond to a user. Upon moving the switch 155 to a switch position, the vehicle controller 120 may recognize the user and apply the user defined preferences. The switch 155 may also have an “off” position configured to disable steering wheel heating.

The vehicle display 160 may be a display such as an in-vehicle display. The display 160 may include a user interface configured to receive commands from the user. The display 160 may be used to receive user preferences such as steering wheel heating preferences. Such preferences may include a preferred heating location, a preferred timing of the heating (e.g., during start up), a preferred temperature, etc.

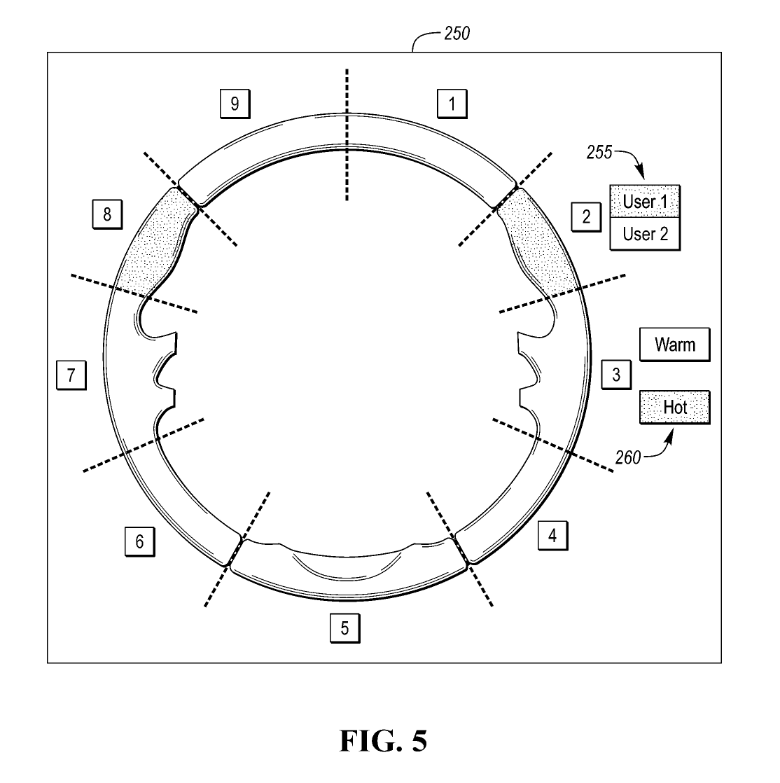

FIG. 5 illustrates an example user interface 250 illustrating an image of the steering wheel with selectable heat mat sections. The user may select certain heat mat sections by tapping on those sections. In the example shown in FIG. 5, the user has selected sections 2 and 8. A user selection section 255 may permit different users to associate various preference with their profile. In the example of FIG. 5, user 1 is selected. A temperature preference 260 may also be included in the interface. The temperature preference 260 is shown by way of example to include “warm” and “hot” temperature options. However, additionally or alternatively, these options may include specific temperatures or temperature ranges. Further, the temperature preferences may include heat preferences for each heat mat section.

Other options may be included and displayed via the interface 250. For example, the timing of heating may be selected such as “at key on” or “at vehicle start.” A duration may also be selected such as “5 minutes” or “20 minutes.” These selectable options may be displayed on a single interface. Additionally, or alternatively, several interfaces may be displayed and prompted to receive user input. Drop-down menus may be used, as well as voice commands in lieu of tactile selections.

Referring back to FIG. 1, the key fob 165 may be a vehicle key fob typically used to gain access to a vehicle cabin by transmitting unique wireless commands. The vehicle controller 120 may authenticate the key fob 165, allowing access to the vehicle, as well as enabling vehicle features such as vehicle start, etc. The key fob 165 may also identify a user via the unique wireless response. For example, a vehicle may authenticate more than one key fob, each with its own identification and/or unique key. Each unique key may be associated with a specific user. Each user may be associated with the user steering wheel heating preferences. Upon authentication of a key fob, the preferences associated with the user identified by the key fob 165 may be applied.

A mobile device 170 may communicate with the vehicle controller 120 wireless via a wireless communication network such as a cellular network. The mobile device 170 may communication with the vehicle controller 120 via the vehicle telematics systems. The mobile device 170 may communicate with the vehicle and subsequently identify a user associated with the mobile device 170. In one example, where the mobile device 170 is used to unlock the vehicle, the authentication used to unlock the vehicle may also identify the user.

The vehicle controller 120 may be configured to receive the user identification from the vehicle interfaces 150. As explained, the user identification may be explicit via a switch position. The user identification may be inferred via other unique identifiers such as those provided by the key fob 165 and mobile device 170.

The vehicle controller 120 may interface via wired or wireless communication, with a steering wheel controller 180. The steering wheel controller 180 may include a processor configured to carry out instructions for the systems and methods disclosed herein. In one example, the steering wheel controller 180 may be a special purpose controller for the heated steering wheel system 100. Although not shown, the steering wheel controller 180 may also be remote from the vehicle and configured to communicate with another on-board controller for carrying out instructions for the vehicle steering wheel assembly 105.

The steering wheel controller 180 may include at least one controller connector 187 configured to connect with the steering wheel connector 147. The controller connector 187 may include at least one pin connector configured to interface with the steering wheel connector 147 of the steering wheel assembly 105.

The steering wheel connector 147 may include a power connector 157 and a feedback connector 159. The controller connector 187 may also include a power connector 189 and a feedback connector 183. The power connector 157 may facilitate power transfer to one of the wires 143. The feedback connectors 159, 193 may facilitate data transfer from the steering wheel assembly 105 to the steering wheel controller 180 and/or the vehicle controller 120.

The steering wheel controller 180 may include a database 177 configured to maintain a list of user and associated user preferences. The steering wheel controller 180 may receive a user identification from the vehicle controller 120 and in turn provide a look-up of user preferences associated with the identified user.

The heated steering wheel system 100 may include a power supply 190 configured to provide current to the heat mat 140. This may be achieved by opening various switches within the connectors 147, 187 to permit certain ones of the heat mats 140 to receive current from the power supply 190. In one example, the power supply 190 may be an on-board power supply such as a vehicle battery.

FIG. 4 illustrates a schematic for the example steering wheel system 100. The steering wheel assembly 105 may include a plurality of heat mat sections 110a-n. As explained, each heat mat section 110 may include a corresponding heat mat 140 (i.e., heat mats 140a-n) configured to heat the steering wheel assembly upon receiving current from the power supply 190. Each heat mat section 110 may also include a negative temperature coefficient (NTC) sensor 205 (i.e., sensors 205a-n). The sensor 205 may be a thermistor whose resistance depends on a temperature.

Each heat mat 140 may be connected to the steering wheel connector 147 via a first wire 214. Each sensor 205 may be connected to the steering wheel connector 147 via a second wire 216. The first wire and second wire 216 are illustrated as the wires 143 in FIG. 2 for simplicity. The wires may be bundled with a wire harness during manufacturing to maintain the wires within a steering wheel column.

The steering wheel connector 147 may include power distribution unit 212. The power distribution unit 212 may be a connector configured to receive the first wires 214. The power distribution unit 212 may then connect to the power connector 189. The steering wheel connector 147 may include a feedback distribution unit 218 configured to receive the second wires 216 from the sensors 205. The feedback distribution unit 218 may then connect to the feedback connector 193.

The steering wheel connector 147 may provide a connection of the wires 214, 216 to the controller connector 187 of the steering wheel controller 180. The sensors 205 may provide feedback data to the steering wheel controller 180 via the steering wheel connector 147. The feedback data may include data indicative of a status of the associate heat mat 140. For example, the feedback data may include a temperature, or a resistance indicative of a temperature. The steering wheel controller 180 may receive the temperature and determine whether the heat mat 140 has reached, exceed, or not yet reached a desired temperature as set by the user preferences. The steering wheel controller 180 may then adjust the current supplied to the associated heat mat in response to the feedback data including a temperature that differs from that defined by the user preferences.

Accordingly, a customizable heated steering wheel system is provided that allows for efficient heating of the steering wheel via various wires and connectors. The feedback provided to the controller may facilitate accuracy with respect to achieving user preferences, while not unduly burdening the power supply of the system.

Computing devices described herein, such as the controllers 120, 180, mobile device 170, etc., generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a steering wheel assembly including a plurality of heat mat sections configured to selective heat a subset of the steering wheel; and
a controller coupled to the heat mat sections via at least one connector, the controller configured to instruct the connector to provide current to at least one of the heat mat sections based on a user preference associated with an identified user.

2. The system of claim 1, wherein the controller is further programmed to identify the user upon recognizing a key fob associated with the user.

3. The system of claim 1, wherein the controller is further programmed to identify the user upon recognizing a mobile device associated with the user.

4. The system of claim 1, wherein the user preference includes a temperature preference associated with each heat mat section.

5. The system of claim 1, further comprising a display configured to receive the user preference and communicate the user preference to the controller.

6. The system of claim 5, wherein the display includes a steering wheel image including visual indications of the heat mat sections.

7. The system of claim 1, wherein the at least on connector includes a steering wheel connector and a controller connector, the steering wheel connector configured to couple wires from the heat mat section to the controller connector.

8. The system of claim 1, wherein each heat mat section includes a sensor configured to provide feedback data indicative of a status of the associated heat mat to the controller.

9. A steering wheel assembly, comprising:
a steering wheel;
a plurality of heat mat sections surrounding the steering wheel and configured to selectively heat a respective subset of the steering wheel; and
a controller coupled to the heat mat sections via at least one connector, the controller configured to instruct the connector to provide current to at least one of the heat mat sections based on a user preference associated with an identified user.

10. The assembly of claim 9, wherein the controller is further programmed to identify the user upon recognizing a key fob associated with the user.

11. The assembly of claim 9, wherein the controller is further programmed to identify the user upon recognizing a mobile device associated with the user.

12. The assembly of claim 9, wherein the user preference includes a temperature preference associated with each heat mat section.

13. The assembly of claim 9, further comprising a display configured to receive the user preference and communicate the user preference to the controller.

14. The assembly of claim 13, wherein the display includes a steering wheel image including visual indications of the heat mat sections.

15. The assembly of claim 9, wherein the at least on connector includes a steering wheel connector and a controller connector, the steering wheel connector configured to couple wires from the heat mat section to the controller connector.

16. The assembly of claim 9, wherein each heat mat section includes a sensor configured to provide feedback data indicative of a status of the associated heat mat to the controller.
